(19) United States
(12) Patent Application Publication
(10) Pub. No.: US 2012/0032014 A1
(43) Pub. Date: Feb. 9, 2012

(54) BLADE ASSEMBLY FOR PAPER SHREDDER

(75) Inventor: Tie-Chun WANG, SanChung City (TW)

(73) Assignee: Michilin Prosperity Co., Ltd., SanChung City (TW)

(21) Appl. No.: 12/850,924

(22) Filed: Aug. 5, 2010

(51) Int. Cl. B02C 7/12

(52) U.S. Cl. 241/296

(57) ABSTRACT

A blade assembly for paper shredder consists of a first blade and a second blade combined back to back. Each blade has a circular blade flank formed by punching a thin sheet metal. The blade flank has a hole at its center and integrally extends outwards with at least two cutting edges. Each cutting edge has a base portion extended from the blade flank outwards and on the same plane as the blade flank, a surface portion bent from the base portion to the back of the blade flank and perpendicular to the blade flank, and a tip portion formed between the base portion and the surface portion. The blade flank is integrally formed with several ribs protruding towards the blade flank. A portion of the rib is formed beneath the tip to support the cutting edge and to enhance its strength.

### BACKGROUND OF THE INVENTION

1. Field of Invention

The invention relates to a shredder and, in particular, to a blade assembly for paper shredder formed by combining a first blade and a second blade back to back.

2. Related Art

As is well known, the action principle of a shredder for shredding paper is to dispose a plurality of blades on two rotary shafts with spacers in between. A motor and a gearbox are employed to drive the two parallel rotary shafts that rotate in opposite directions. They provide a shearing force on passing paper to cut it into small stripes.

In the wake of increasing raw material costs and a competitive market, manufacturers have developed various lightweight blades that are made from thin sheet metal and formed by machine punching. Such blades have the advantages of saving the steel material and reducing the weight of shredder. Therefore, this trend has become the mainstream of the industry. The products introduced in China Pat. Nos. 200620056133.1, 200620014030.9, and 200620014187.1 are such examples.

However, it is widely suspected that whether the strength of the cutting edges is sufficient for the stability required in long-time uses if the blade thickness is reduced for saving the steel material. Although the above-mentioned China patents all propose to use protruding rings or protruding ribs to reinforce the blades, the effect only applies to the blade flank. The cutting edges of the blade directly used to cut paper sheets is not strongly supported. Therefore, this could be a serious problem in the trend of using lightweight blades.

### SUMMARY OF THE INVENTION

In view of the foregoing, the inventor provides a blade assembly for paper shredder to solve the existing problems.

The blade assembly for paper shredder consists of a first blade and a second blade combined back to back. Each blade has a circular blade flank formed by punching a thin sheet metal. The blade flank has a hole at its center and integrally extends outwards with at least two cutting edges. Each cutting edge has a base portion extended from the blade flank outwards and on the same plane as the blade flank, a surface portion bent from the base portion to the back of the blade flank and perpendicular to the blade flank, and a tip portion formed between the base portion and the surface portion. The blade flank is integrally formed with several ribs protruding towards the blade flank. A portion of the rib is formed beneath the tip portion to support the cutting edge and to enhance its strength.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the first blade in the invention;

FIG. 2 is a three-dimensional view of the second blade in the invention; and

FIG. 3 is a three-dimensional view of the blade assembly composed of the first and second blades.

### DETAILED DESCRIPTION OF THE INVENTION

The present invention will be apparent from the following detailed description, which proceeds with reference to the accompanying drawings, wherein the same references relate to the same elements.

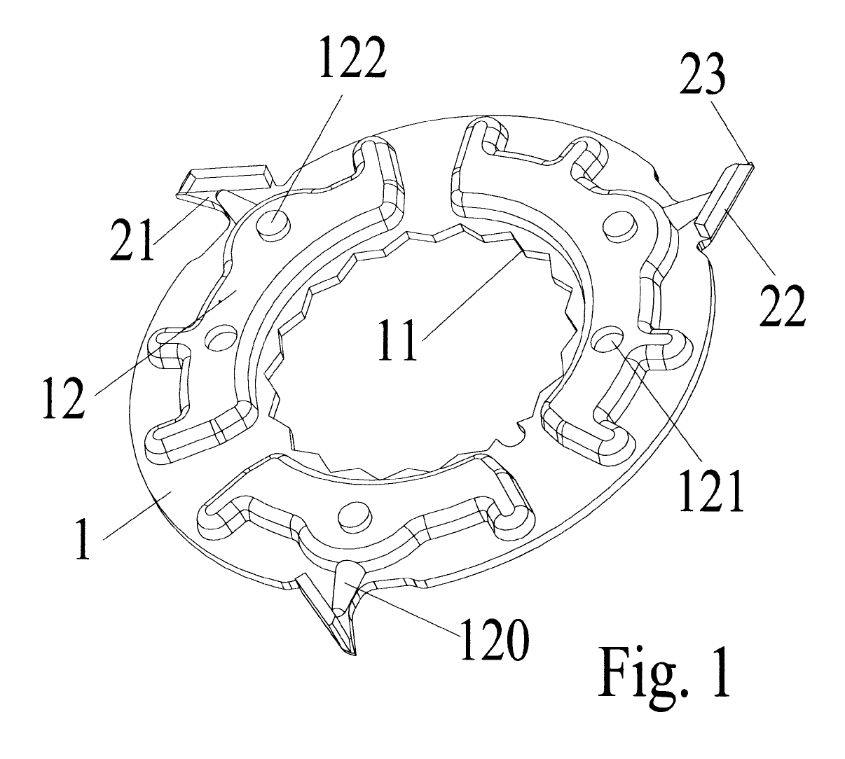

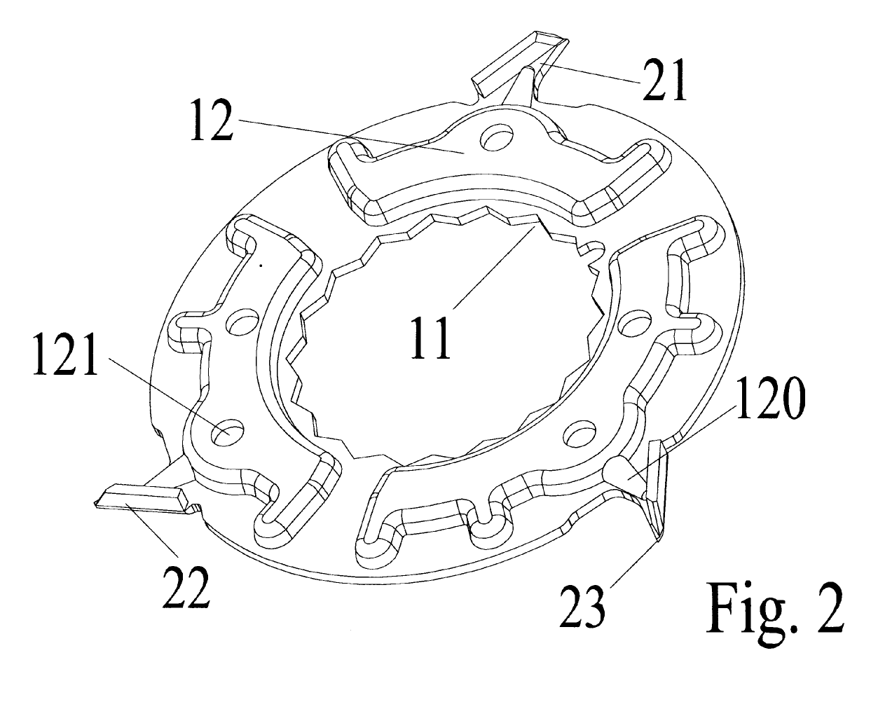

In the following description, please refer to FIGS. 1, 2 and 3 for different three-dimensional views of certain parts of the invention. Each blade is made from a thin sheet metal and is formed with a circular blade flank 1 by punching. In addition to making a polygonal hole 11 at the center of the blade flank 1, it is integrally extended outwards with at least two cutting edges.

Each cutting edge has a base portion 21 extended from the blade flank 1 outwards and on the same plane as the blade flank 1, a surface portion 22 bent from the base portion 21 to the back of the blade flank 1 and perpendicular to the blade flank 1, and a tip portion 23 formed between the base portion 21 and the surface portion 22.

To reinforce the ability of anti-bent of the thin blade, the blade flank 1 is integrally formed with several ribs 12 in the shape of camel hump protruding from the back of the blade flank 1. One of the camel humps of the ribs 12 extends toward the tip portion 23 of the cutting edge to form a conic part 120, providing a strong support for the cutting edge. This can compensate for the reduced strength due to thin blades.

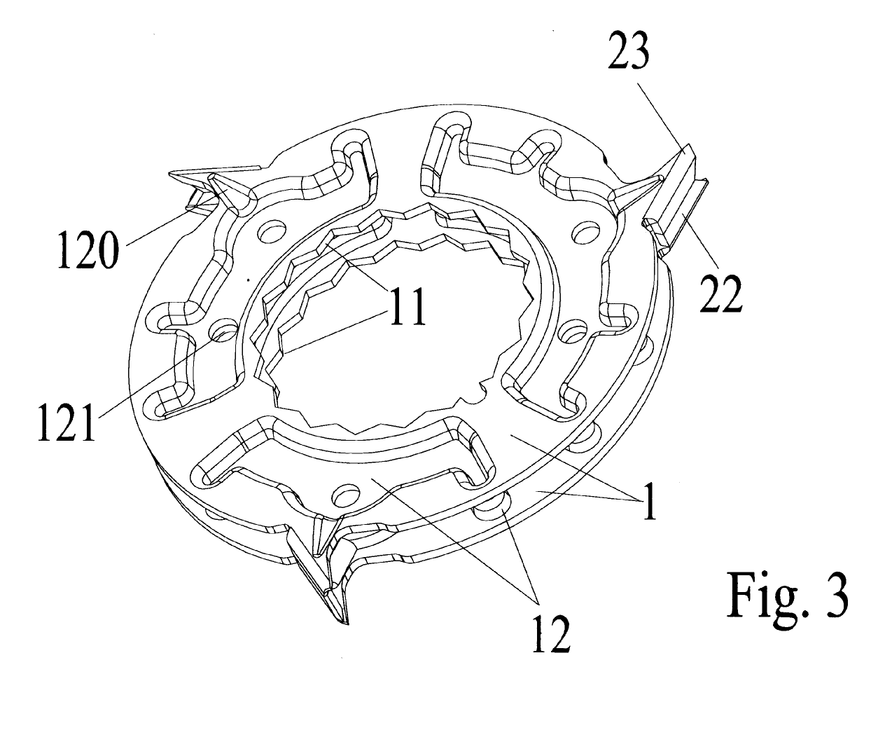

The enforced rib 12 of each blade has several holes 121 or pins 122. When two blades are combined back to back as shown in FIG. 3, the corresponding holes 121 and pins 112 are matched to firmly form a blade assembly for paper shredder.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A blade assembly for paper shredder consisting of a first blade and a second blade combined back to back; wherein
each of the blades is made from a thin sheet metal and has a circular blade flank formed by punching, and the center of the blade flank is formed with a hole and integrally extended outwards with at least two cutting edges;
each of the cutting edges includes a base portion extended from the blade flank outwards and on the same plane as the blade flank, a surface portion bent from the base portion to the back of the blade flank and perpendicular to the blade flank, and a tip portion formed between the base portion and the surface portion; and
the blade flank is integrally formed with a plurality of ribs protruding towards the back of the blade flank, and a portion of the rib is formed beneath the tip portion to support the cutting edge and to enhance its strength.

2. The blade assembly for paper shredder of claim 1, wherein the rib of each of the blades roughly has the shape of camel hump.

3. The blade assembly for paper shredder of claim 2, wherein one of the camel humps of the ribs is extended with a conic part towards the tip portion of the cutting edge to support the cutting edge and to enhance its strength.

4. The blade assembly for paper shredder of claim 1, wherein the ribs of the first blade are formed with a plurality of holes and pins for connection.

5. The blade assembly for paper shredder of claim 1, wherein the ribs of the second blade are formed with pins and holes at positions corresponding to the holes and pins on the ribs of the first blade, respectively.
